(19) United States
(12) Patent Application Publication
(10) Pub. No.: US 2012/0262096 A1
(43) Pub. Date: Oct. 18, 2012

(54) ELECTRIC VEHICLE AND OPERATING METHOD OF THE SAME

(76) Inventors: Junggi Lee, Seoul (KR); Junbo Yun, Seoul (KR); Junyoung Lim, Seoul (KR); Sunkyoung Lim, Seoul (KR)

(21) Appl. No.: 13/444,391

(22) Filed: Apr. 11, 2012

(30) Foreign Application Priority Data
Apr. 13, 2011 (KR) 10-2011-0034344

(51) Int. Cl. H02P 6/14; H02J 7/02

(52) U.S. Cl. 318/139; 320/137

(57) ABSTRACT

Disclosed herein is an electric vehicle and a driving method thereof. According to the present disclosure, it may be possible to drive an electric vehicle using a drive inverter and coils within a three-phase motor, and charge a battery using them as a charging device. According to the present disclosure, coils included in a motor control device and switching elements within an inverter may be used, and the use of the inductors and switching elements required for the charging device may be reduced.

### CROSS-REFERENCE TO RELATED APPLICATIONS

Pursuant to 35 U.S.C. §119(a), this application claims the benefit of earlier filing date and right of priority to Korean Application No. 10-2011-0034344 filed on Apr. 13, 2011, the contents of which are incorporated by reference herein in its entirety.

### BACKGROUND OF THE DISCLOSURE

1. Field of the Disclosure

The present disclosure relates to an electric vehicle in which a battery is charged using a drive motor.

2. Background of the Disclosure

Electric vehicle (EV) refers to a vehicle using a battery and an electric motor without using petroleum fuel and an engine. The electric vehicle can be largely classified into an electric vehicle using only an electric battery and a hybrid electric vehicle using other power sources such as gasoline and the electric battery together. An electric vehicle in which a motor is rotated by electricity stored in a battery to drive the vehicle was first manufactured before 1873 when a gasoline vehicle was manufactured. However, the electric vehicle was not put to practical use due to the problems of a heavy weight of battery, the time taken for charging, and the like. In recent years, studies for electric vehicles have been actively carried out due to the problems of a shortage of energy resources such as fossil fuels, environmental pollution caused by gasoline vehicles, and the like.

An electric vehicle uses a blushless DC motor or induction motor as a driving motor, or modifies them as necessary prior to use. Furthermore, the electric vehicle may include a drive inverter for driving a motor and an on-board charge (OBC) for charging a battery in an independent manner. When the electric vehicle is driven, only the drive inverter is used without using the OBC. On the contrary, when the electric vehicle is in an idle state, only the OBC is used without using the drive motor.

### SUMMARY OF THE DISCLOSURE

According to the embodiments of the present disclosure, an object thereof is to provide an electric vehicle and a driving method thereof capable of maintaining the function of an inverter included in a motor control device as well as using it as a charging device to charge a battery.

According to the embodiments of the present disclosure, another object thereof is to provide an electric vehicle and a driving method thereof capable of performing a driving and charging operation using a drive inverter and coils in a three-phase motor.

In order to accomplish the foregoing object, an electric vehicle according to an embodiment may include a battery to supply direct current power, an inverter including three inverter modules to convert the direct current power into three-phase alternating current power, at least one inverter module including two switching units, a three-phase motor having three phase coils connected to the three inverter modules, respectively, to be driven by the three-phase alternating current power, wherein one side of the three phase coils are connected to the three inverter modules, respectively, and another side of two coils out of the three phase coils are connectable to a charging power, and another side of remaining coil out of the three phase coils is connectable to the battery.

The electric vehicle may further include a controller to output a control signal to the inverter to drive the three inverter modules. Also, the electric vehicle may further include at least one switch unit provided between the battery and the direct current link capacitor to separate a connection between the battery and the direct current link capacitor when charging the battery.

In order to accomplish the foregoing object, an electric vehicle according to another embodiment may include a battery to supply direct current power, a direct current link capacitor to smooth out and store the direct current power, an inverter including three inverter modules to convert the direct current power smoothed out by the direct current link capacitor into three-phase alternating current power according to a control signal, at least one inverter module including two switching units having switching elements and diodes connected in parallel with the switching elements, a three-phase motor having three phase coils connected to the three inverter modules to be driven by the three-phase alternating current power, and a controller to output a control signal to the inverter to drive the inverter, wherein the switching elements are switched according to the control signal when driving the electric vehicle, and opened when charging the battery.

In order to accomplish the foregoing objects, a method of driving an electric vehicle according to an embodiment may include sensing whether a charging power is connected to the electric vehicle, connecting the three phase coils to one neutral point, and outputting the control signal to the inverter to drive the three-phase motor when the sensing indicates that the charging power is not connected to the electric vehicle, and connecting two coils out of the three phase coils to the charging power, and connecting remaining one coil out of the three phase coils to the battery to charge the battery when the sensing indicates that the charging power is connected to the electric vehicle.

According to the embodiments of the present disclosure, it may be possible to drive an electric vehicle using a drive inverter and coils within a three-phase motor, and charge a battery using them as a charging device.

According to the embodiments of the present disclosure, coils included in a motor control device and switching elements within an inverter may be used, and the use of the inductor and switching elements required for the charging device may be reduced, thereby reducing the cost as well as decreasing the size of a system.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

In the drawings:

FIG. 1 is a view schematically illustrating an example of an electric vehicle according to the present disclosure;

FIG. 2 is a view schematically illustrating the configuration of a motor control device in an electric vehicle according to an embodiment of the present disclosure;

FIG. 3 is a circuit diagram for explaining the operation for driving an electric vehicle in FIG. 2;

FIG. 4 is a circuit diagram for explaining the operation for charging an electric vehicle in FIG. 2;

FIG. 5 is an equivalent circuit diagram of FIG. 4;

FIG. 6 is a circuit diagram for explaining the operation for driving an electric vehicle in the electric vehicle according to another embodiment of the present disclosure;

FIG. 7 is a circuit diagram for explaining the operation for charging an electric vehicle in FIG. 6; and

FIG. 8 is a flow chart schematically illustrating a method of driving an electric vehicle according to an embodiment of the present disclosure.

### DETAILED DESCRIPTION OF THE DISCLOSURE

Referring to FIG. 1, an electric vehicle according to an embodiment of the present disclosure may include a battery 100 for supplying direct current power, a power module 150 for converting direct current power supplied by the 100 into alternating current power to generate a rotational force, a front wheel 510 and a rear wheel 520 rotated by the power module 150, and a front suspension device 610 and a rear suspension device 620 for blocking vibration of the road surface from being transferred to a vehicle body. Furthermore, the electric vehicle may further include a drive gear (not shown) for converting the rotation speed of a three-phase motor 300 according to a gear ratio.

The power module 150 may include a motor control device 200 for receiving direct current power from the battery 100, and a three-phase motor 300 configured to be driven by the motor control device 200 to generate a rotational force.

The battery 100 supplies direct current power to the power module 150. The battery 100 forms a set in which a plurality of unit cells are connected in series and/or parallel. The plurality of unit cells are managed to maintain a constant voltage by a battery management system (BMS). In other words, the battery management system allows the battery 100 to output a constant voltage. The battery 100 may be preferably configured with a secondary cell capable of performing a charging and discharging operation, but not be limited to this. In general, nickel-metal hydride (Ni-MH) batteries, lithium ion (Li-ion) batteries, or the like may be used for the battery 100.

The motor control device 200 receives direct current power from the battery 100. The motor control device 200 converts direct current power received from the battery 100 into alternating current power and supplies it to the three-phase motor 300. In general, the motor control device 200 supplies three-phase power to the motor.

The three-phase motor 300 may include a stator (not shown) being stationary with no rotation, and a rotor (not shown) being rotated, and the three-phase motor 300 receives alternating current power supplied from the motor control device 200 to generate a rotational force. If alternating current power is applied to the three-phase motor 300, then the stator of the three-phase motor 300 receives alternating current to generate a magnetic field. In case of a motor having a permanent magnet, a magnetic field generated from the stator repulses a magnetic field of the permanent magnet provided in the rotor to rotate the rotor. A rotational force is generated by the rotation of the rotor.

A drive gear (not shown) may be provided at one side of the three-phase motor 300. The drive gear converts a rotational force of the three-phase motor 300 according to a gear ratio. The rotational force outputted from the drive gear is transferred to a front wheel 510 and/or rear wheel 520 to move the vehicle.

The front suspension device 610 and rear suspension device 620 support the front wheel 510 and rear wheel 520, respectively, with respect to a vehicle body. The front suspension device 610 and rear suspension device 620 do not allow vibration of the road surface to be transferred to the vehicle body by means of a spring or damping mechanism.

The front wheel 510 may further include a steering device (not shown). The steering device is a device of controlling the direction of the front wheel 510 to move a vehicle in a direction consistent with the driver's intention.

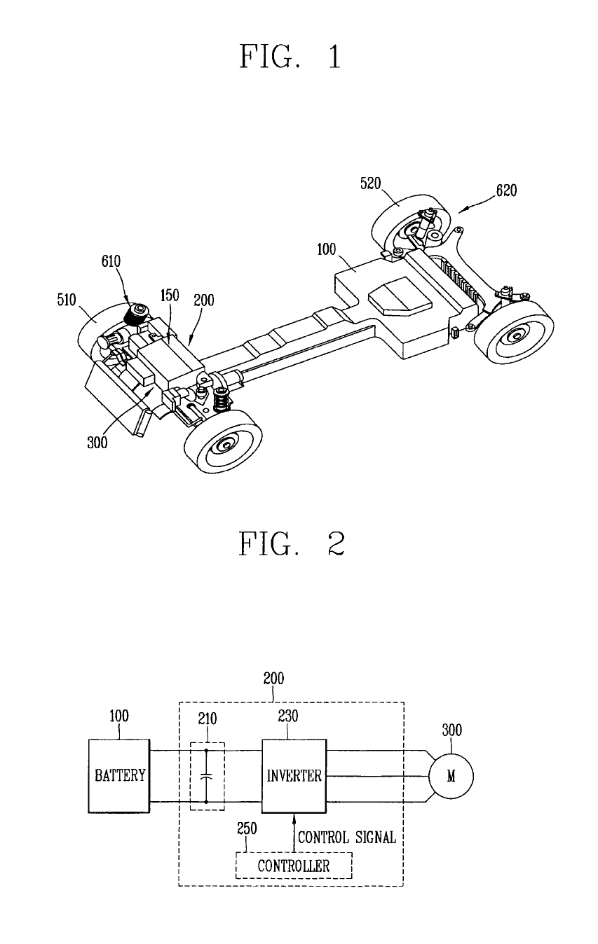

Referring to FIG. 2, an electric vehicle according to an embodiment of the present disclosure may include a battery 100, a motor control device 200, and a three-phase motor 300. The battery 100 supplies direct current power to an electric vehicle. The motor control device 200 may include a direct current link capacitor 210 for smoothing out and storing the direct current power, an inverter 230, and a controller 250.

The electric vehicle may further include a direct current-direct current converter (not shown) for converting a driving power of the battery 100 into a constant direct current voltage. The direct current-direct current (DC-DC) converter may include switching elements, for example, insulated gate bipolar transistors (hereinafter, referred to as “IGBTs”) which are driven according to a control signal of the controller. Furthermore, the converter may further include a reactor if necessary.

The direct current link capacitor 210 is connected between the battery 100 and the inverter 230 to smooth out and store an output direct current voltage of the battery.

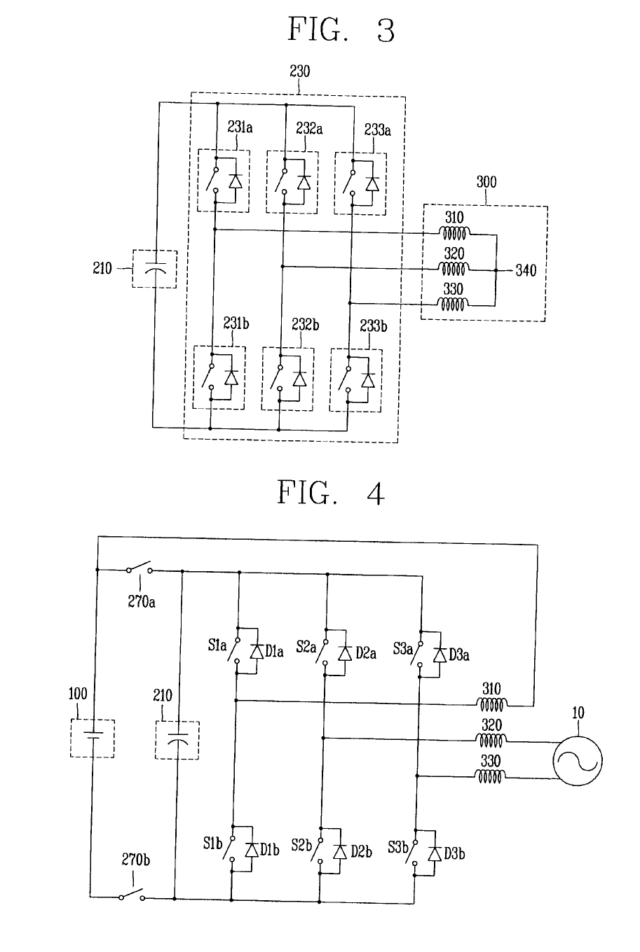

Referring to FIG. 3, the inverter 230 may include three inverter modules 231, 232, 233 configured with two switching units. Furthermore, the inverter 230 converts the direct current power smoothed out by the direct current link capacitor 210 into three-phase alternating current power according to a control signal. The switching units 231a, 231b, 232a, 232b, 233a, 233b may include switching elements S1a, S1b, S2a, S2b, S3a, S3b driven by a control signal and diodes D1a, D1b, D2a, D2b, D3a, D3b connected in parallel with the switching elements. The switching elements are switching elements such as metal oxide semiconductor field effect transistors (MOSFETs), IGBTs, or the like. The switching elements receives a control signal from the controller 250 to be turned on or off according to the control signal. The control signal is a signal for controlling a duty ratio of the switching elements. The diodes are connected in parallel with the switching elements, respectively, to form current paths when they are turned on or off by switching, thereby performing the function of a free-wheeling diode that consumes a residual current.

The three-phase motor 300 may include three phase coils 310, 320, 330 connected to the three inverter modules to be driven according to the three-phase alternating current power. The controller 250 generates the control signal and outputs it to the inverter 230 to drive the three inverter modules.

As illustrated in FIG. 3, when driving an electric vehicle, namely, when driving a three-phase motor, the three phase coils 310, 320, 330 are connected to one neutral point 340. On the contrary, referring to FIG. 4, one sides of the three phase coils 310, 320, 330 are connected to the three inverter modules, respectively, when charging a battery. Furthermore, when charging the battery 100, the other sides of two phase coils 320, 330 of the three phase coils are connected to a power source 10 for charging, and the other side of one phase coil 310 thereof is connected to the battery 100. Here, the three-phase motor 300 may further include a select unit (not shown) configured to connect or separate the three phase coils to or from one neutral point 340 so as to connect two phase coils 320, 330 to the charging power and connect the remaining one phase coil 310 to the battery 100. The select unit is an electrical/mechanical switch provided in the three-phase motor to be turned on or off according to a switching signal from the controller 250.

Referring to FIG. 4, the electric vehicle may further include a pair of switch units 270a, 270b between the battery and the direct current link capacitor. The pair of switch units 270a, 270b connects the battery to the direct current link capacitor when driving the three-phase motor whereas separates a connection between the battery and the direct current link capacitor. The pair of switch units are electrical/mechanical switches configured to be turned on or off according to a switching signal. Here, the controller 250 outputs a switching signal for separating a connection between the battery 100 and the direct current link capacitor 210 to the pair of switch units when a power source 10 for charging is connected to the three-phase motor 300.

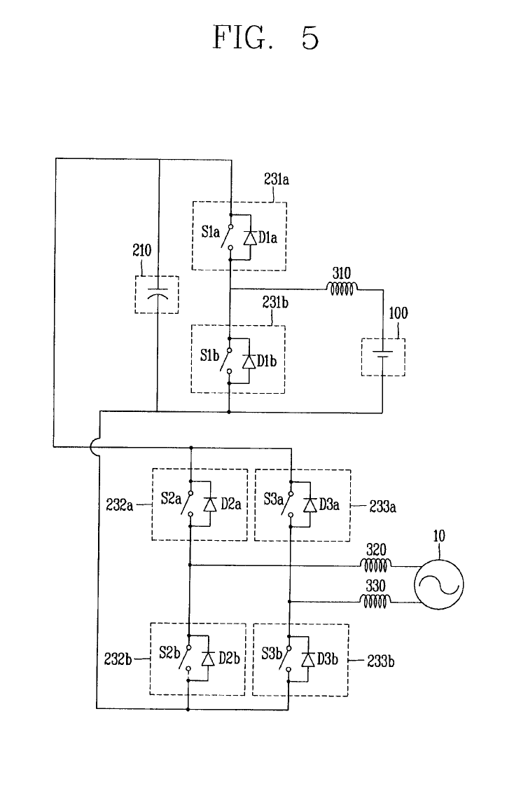

Referring to FIG. 5, two inverter modules 232, 233 of the three inverter modules 231, 232, 233 form an alternating current-direct current converter for converting the power source 10 for charging into direct current power when charging the battery. Here, the alternating current-direct current converter is operated as a power factor correction converter according to the switching of switching elements included in the two inverter modules. The power factor correction converter converts the charging power into direct current power, and corrects power factor and supplies it to the direct current link capacitor 210. For example, when the charging power is the commercial AC 220 V, the power factor correction converter rectifies it to about 320 V and corrects power factor, and then boosts the voltage to about 600 to 700 V and supplies it to the direct current link capacitor. Furthermore, the remaining inverter module 231 of the three inverter modules forms a buck-boost converter together with a coil 310 connected to the battery 100. The buck-boost converter is connected to the direct current link capacitor to convert the voltage into a suitable allowable battery voltage range by current control so as to supply the converted voltage to the battery.

The controller 250 may include a coordinate conversion unit for converting a motor drive current into a synchronous coordinate system, and a current controller for receiving a torque instruction and a magnetic flux instruction, and receiving the motor drive current converted through the coordinate conversion unit to output a voltage instruction. The controller 250 may further include a pulse width modulation controller for generating a control signal that drives an inverter based on the voltage instruction to output it to the inverter 230.

The current controller receives a current instruction and a motor drive current, and outputs a voltage instruction. The current controller receives a d-axis current instruction (i^{e}*ds) and a q-axis current instruction (i^{e}*qs). The current controller proportionally integrates and filters the q-axis current instruction (i^{e}*qs) to output a q-axis synchronous coordinate system voltage instruction (V^{e}*qs). In other words, the current controller compares the q-axis current instruction (i^{e}*qs) with the q-axis output current (i^{e}q) into which a motor drive current has been coordinate-converted by the coordinate conversion unit, and proportionally integrates and filters its difference, i.e., current error, to output q-axis voltage instruction (V^{e}*q). Meanwhile, the current controller also proportionally integrates and filters the d-axis current instruction (i^{e}*ds) to output d-axis voltage instruction (V^{e}*d). In other words, the current controller compares the d-axis current instruction (i^{e}*ds) with the d-axis output current (i^{e}d) into which the motor drive current has been coordinate-converted, and proportionally integrates and filters its difference, i.e., current error, to output d-axis voltage instruction (V^{e}*d) to the PWM controller. Here, “e” denotes a synchronous coordinate system.

The PWM controller combines effective voltage vectors that can be outputted from the inverter 230 during a control period (Ts) and generates the control signal so as to follow the voltage instruction to output it to the inverter 230. The control signal is a gating signal input to a gate of the IGBT.

The controller 250 may further include a synchronous coordinate inverse conversion unit for converting a synchronous coordinate system voltage instruction into a stationary coordinate system voltage instruction. The synchronous coordinate inverse conversion unit is disposed between the current controller and PWM controller to convert a synchronous coordinate system voltage instruction (V^{e}*d, V^{e}*q) into (V^{s}*d, V^{s}*q) which is a stationary coordinate system voltage instruction (V^{s}*). Here, “e” denotes a synchronous coordinate system, and “s” denotes a stationary coordinate system. The PWM controller converts a voltage instruction of the stationary coordinate system into a suitable form of a motor to be driven to output it. The PWM controller converts a voltage instruction of the stationary coordinate system into a three-phase voltage instruction (Va*, Vb*, Vc*) and outputs it to the three-phase motor 300. The synchronous coordinate inverse conversion unit may be included in the PWM controller. The PWM controller generates a control signal based on a voltage instruction for each phase, and outputs the control signal to the inverter to turn on or off switching elements in the inverter.

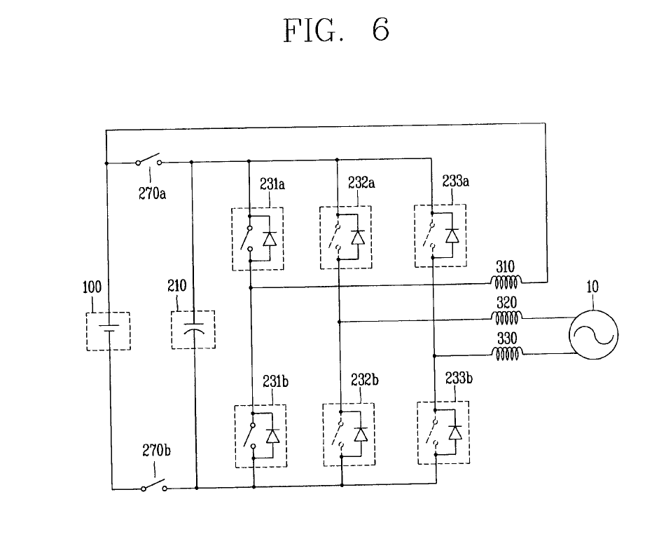

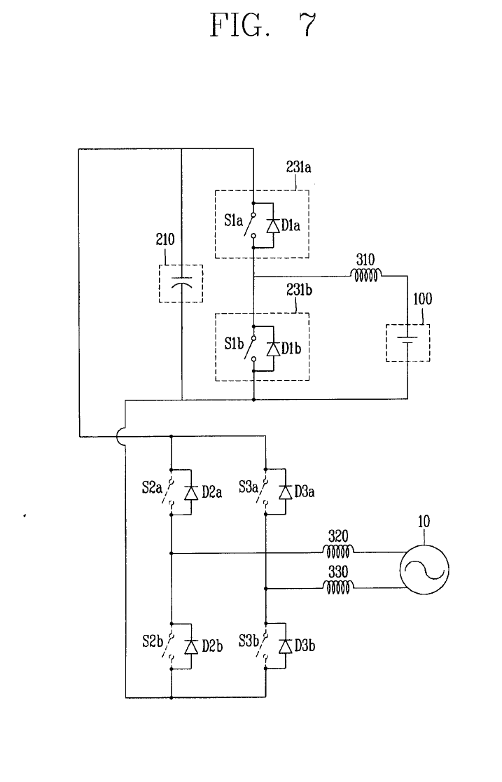

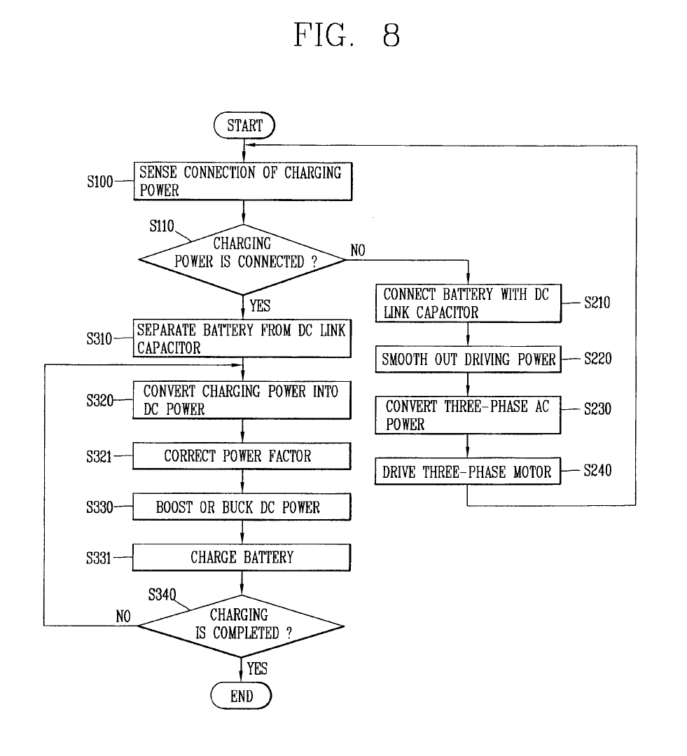

Referring to FIGS. 6 and 7 together, an electric vehicle according to another embodiment of the present disclosure may include a battery 100, a motor control device 200, and a three-phase motor 300 as illustrated in the foregoing embodiment. The battery 100 supplies direct current power to an electric vehicle. The motor control device 200 may include a direct current link capacitor 210 for smoothing out and storing the direct current power, an inverter 230, and a controller 250. The electric vehicle may further include a converter (not shown) for converting a driving power of the battery 100 into a constant direct current voltage.

The direct current link capacitor 210 is connected between the converter and the inverter 230 or between the battery 100 and the inverter 230 to smooth out and store an output direct current voltage of the battery.

The inverter 230 may include three inverter modules 231, 232, 233 configured with two switching units. Furthermore, the inverter 230 converts the direct current power smoothed out by the direct current link capacitor 210 into three-phase alternating current power according to a control signal. The switching unit may include switching elements driven by a control signal and diodes connected in parallel with the switching elements, respectively. The switching elements are switching elements such as MOSFETs, IGBTs, or the like.

The three-phase motor 300 may include three phase coils 310, 320, 330 connected to the three inverter modules to be driven according to the three-phase alternating current power. The controller 250 generates the control signal and outputs it to the inverter 230 to drive the three inverter modules.

When driving an electric vehicle, namely, when driving a three-phase motor, the three phase coils 310, 320, 330 are connected to one neutral point 340. On the contrary, as illustrated in FIGS. 6 and 7, one sides of the three phase coils 310, 320, 330 are connected to the three inverter modules, respectively, when charging a battery. Furthermore, when charging the battery 100, the other sides of two phase coils 320, 330 of the three phase coils are connected to a power source 10 for charging, and the other side of one phase coil 310 thereof is connected to the battery 100. Here, the three-phase motor 300 may further include a select unit (not shown) configured to connect or separate the three phase coils to or from one neutral point 340 so as to connect two phase coils 320, 330 to the charging power and connect the remaining one phase coil 310 to the battery 100.

Referring to FIG. 6, the electric vehicle may further include a pair of switch units 270a, 270b between the battery and the direct current link capacitor. The pair of switch units 270a, 270b connect the battery to the direct current link capacitor when driving the three-phase motor whereas separate a connection between the battery and the direct current link capacitor.

Referring to FIG. 7, two inverter modules 232, 233 of the three inverter modules 231, 232, 233 form an alternating current-direct current converter for converting the power source 10 for charging into direct current power when charging the battery. Here, switching elements included in the two inverter modules always are open. In other words, the alternating current-direct current converter forms a full-bridge diode to rectify a charging power into direct current power. For example, when the charging power is the commercial AC 220 V, the alternating current-direct current converter rectifies it to about 320 V and supplies it to the direct current link capacitor. Furthermore, the remaining inverter module 231 of the three inverter modules forms a buck-boost converter together with a coil 310 connected to the battery 100. The buck-boost converter is connected to the direct current link capacitor to convert the voltage into a suitable allowable battery voltage range by current control so as to supply the converted voltage to the battery.

Referring to FIG. 8, a method of driving an electric vehicle according to an embodiment may include sensing whether or not a charging power is connected thereto (S100), and connecting the three phase coils to one neutral point, and outputting the control signal to the inverter to drive the three-phase motor (S200) when the charging power is not connected thereto as a result of the sensing (No of S110). Furthermore, the method of driving an electric vehicle may further include connecting two phase coils of the three phase coils to the charging power, and connecting one phase coil to the battery to charge the battery (S300) when the charging power is connected thereto as a result of the sensing (Yes of S110). Hereinafter, FIGS. 1 through 7 will be referred to for the configuration of the device.

The step of charging the battery (S300) may include converting the charging power into direct current power (S320) and boosting or bucking the direct current power to supply it to the battery (S330). Furthermore, the step of charging the battery (S300) may further include separating a connection between the battery and the direct current link capacitor (S310).

Referring to FIG. 5, in a method of driving an electric vehicle according to an embodiment, two inverter modules of the three inverter modules in an inverter form an alternating current-direct current converter for converting a charging power into direct current power when charging the battery (S300). Here, the alternating current-direct current converter is operated as a power factor correction converter according to the switching of switching elements included in the two inverter modules. The power factor correction converter converts the charging power into direct current power (S320), and corrects power factor and supplies it to the direct current link capacitor (S321). For example, when the charging power is the commercial AC 220 V, the power factor correction converter rectifies it to about 320 V (S320) and corrects power factor (S321), and then boosts the voltage to about 600 to 700 V and supplies it to the direct current link capacitor. Furthermore, the remaining inverter module of the three inverter modules forms a buck-boost converter together with a coil 310 connected to the battery 100. The buck-boost converter is connected to the direct current link capacitor to boost or buck the voltage into a suitable allowable battery voltage range by current control (S330) so as to charge the battery (S331).

Referring to FIG. 7, in a method of driving an electric vehicle in another embodiment, two inverter modules of the three inverter modules form an alternating current-direct current converter for converting a charging power into direct current power when charging the battery. Here, switching elements included in the two inverter modules always are open. In other words, the alternating current-direct current converter forms a full-bridge diode to rectify a charging power into direct current power (S320). For example, when the charging power is the commercial AC 220 V, the alternating current-direct current converter rectifies it to about 320 V and supplies it to the direct current link capacitor. Furthermore, the remaining inverter module of the three inverter modules forms a buck-boost converter together with a coil connected to the battery to boost or buck the voltage into a suitable allowable battery voltage range by current control so as to charge the battery.

The step of driving the three-phase motor (S200) may include connecting the battery with the direct current link capacitor (S210), and applying the three-phase alternating current power to the three phase coils to drive the electric vehicle (S240). Furthermore, the step of driving the three-phase motor (S200) may further include smoothing out a driving power and converting it into three-phase alternating current power (S220, S230).

As described above, according to an electric vehicle and a driving method thereof in accordance with embodiments of the present disclosure, it may be possible to drive an electric vehicle using a drive inverter and coils within a three-phase motor, and charge a battery using them as a charging device. According to the present disclosure, switching elements within the coil and inverter included in a motor control device can be used, and the use of the inductor and switching elements required for the charging device can be reduced.

What is claimed is:

1. An electric vehicle comprising:
a battery to supply direct current power;
an inverter including three inverter modules to convert the direct current power into three-phase alternating current power, at least one inverter module including two switching units; and
a three-phase motor having three phase coils connected to the three inverter modules, respectively, to be driven by the three-phase alternating current power,
wherein one side of the three phase coils are connected to the three inverter modules, respectively, and another side of two coils out of the three phase coils are connectable to a charging power, and another side of remaining coil out of the three phase coils is connectable to the battery.

2. The electric vehicle of claim 1, further comprising:
a controller to output a control signal to the inverter to drive the three inverter modules.

3. The electric vehicle of claim 2, further comprising:
a direct current link capacitor to smooth out and store the direct current power,
wherein the inverter converts the direct current power smoothed out by the direct current link capacitor into three-phase alternating current power according to the control signal.

4. The electric vehicle of claim 3, further comprising:
at least one switch unit provided between the battery and the direct current link capacitor to separate a connection between the battery and the direct current link capacitor when charging the battery.

5. The electric vehicle of claim 4, wherein the controller outputs a switching signal to the at least one switch unit to separate the connection between the battery and the direct current link capacitor when the charging power is connected to the electric vehicle.

6. The electric vehicle of claim 1, further comprises:
a select unit to connect or separate the three phase coils to or from one neutral point so as to connect the two coils out of the three phase coils to the charging power and connect the remaining one coil out of the three phase coils to the battery.

7. The electric vehicle of claim 2, wherein the switching unit comprises:
a switching element to be driven according to the control signal; and
a diode connected in parallel with the switching element.

8. The electric vehicle of claim 7, wherein two of the three inverter modules form an alternating current-direct current converter to convert the charging power into direct current power when charging the battery.

9. The electric vehicle of claim 8, wherein the alternating current-direct current converter is operated as a power factor correction converter according to the switching of switching elements included in two inverter modules.

10. The electric vehicle of claim 8, wherein the remaining one of the three inverter modules operates as a buck-boost converter together with the coil connected to the battery.

11. An electric vehicle comprising:
a battery to supply direct current power;
a direct current link capacitor to smooth out and store the direct current power;
an inverter including three inverter modules to convert the direct current power smoothed out by the direct current link capacitor into three-phase alternating current power according to a control signal, at least one inverter module including two switching units having switching elements and diodes connected in parallel with the switching elements;
a three-phase motor having three phase coils connected to the three inverter modules to be driven by the three-phase alternating current power; and
a controller to output a control signal to the inverter to drive the inverter, wherein the switching elements are switched according to the control signal when driving the electric vehicle, and opened when charging the battery.

12. The electric vehicle of claim 11, wherein one side of the three phase coils are connected to the three inverter modules, respectively, and another side of two coils out of the three phase coils are connectable to a charging power, and another side of remaining coil out of the three phase coils is connectable to the battery when charging the battery.

13. The electric vehicle of claim 12, further comprising:
at least one switch unit provided between the battery and the direct current link capacitor to separate a connection between the battery and the direct current link capacitor when charging the battery.

14. The electric vehicle of claim 11, further comprises:
a select unit to connect or separate the three phase coils to or from one neutral point so as to connect two coils out of the three phase coils to the charging power and connect the remaining one coil out of the three phase coils to the battery.

15. The electric vehicle of claim 12, wherein two of the three inverter modules operate as an alternating current-direct current converter to convert the charging power into direct current power when charging the battery.

16. The electric vehicle of claim 15, wherein remaining one of the three inverter modules operates as a buck-boost converter together with the coil connected to the battery.

17. A method of driving an electric vehicle comprising a battery to supply direct current power; a direct current link capacitor to smooth out and store the direct current power; a pair of switch units provided between the battery and the direct current link capacitor; an inverter including three inverter modules to convert the direct current power smoothed out by the direct current link capacitor into three-phase alternating current power according to a control signal, at least one inverter module including two switching units; and a three-phase motor having three phase coils connected to the three inverter modules, respectively, to be driven by the three-phase alternating current power, the method comprising:
sensing whether a charging power is connected to the electric vehicle;
connecting the three phase coils to one neutral point, and outputting the control signal to the inverter to drive the three-phase motor when the sensing indicates that the charging power is not connected to the electric vehicle; and
connecting two coils out of the three phase coils to the charging power, and connecting remaining one coil out of the three phase coils to the battery to charge the battery when the sensing indicates that the charging power is connected to the electric vehicle.

18. The method of claim 17, wherein the charging of the battery comprises:
converting the charging power into direct current power; and
boosting or bucking the direct current power that is supplied to the battery.

19. The method of claim 18, wherein the charging of the battery further comprises:
separating a connection between the battery and the direct current link capacitor.

20. The method of claim 17, wherein the driving of the three-phase motor comprises:
connecting the battery with the direct current link capacitor; and
applying the three-phase alternating current power to the three phase coils to drive the electric vehicle.
